(19) United States
(12) Patent Application Publication
(10) Pub. No.: US 2022/0028294 A1
(43) Pub. Date: Jan. 27, 2022

(54) SYSTEM AND METHOD FOR EDUCATING TAXI DRIVER PLATFORM USING AUGMENTED REALITY OR VIRTUAL REALITY

(71) Applicant: LECS ACADEMY CO., LTD, Seoul (KR)

(72) Inventor: Chang-Dae YOUN, Yongin-si (KR)

(21) Appl. No.: 17/384,528

(22) Filed: Jul. 23, 2021

(30) Foreign Application Priority Data
Jul. 27, 2020 (KR) 10-2020-0092733

(51) Int. Cl. G09B 9/052; G06T 19/00; G10L 17/22

(52) U.S. Cl. CPC G09B 9/052; G10L 17/22; G06T 19/006

(57) ABSTRACT

A system and a method for educating a taxi driver platform using augmented reality (AR) or virtual reality (VR) is disclosed, which provide a non-face-to-face platform taxi experience education using AR or VR, which switches a legacy offline membership taxi education to a non-face-to-face online education using the AR or VR, and construct a real spatial background using 360-degree images (VR) and add sense of location using the AR and provide a realistic environment to allow trainees to personally practice an experiential education learning contents through an interaction in a produced environment, thereby increasing an educational learning ability of the trainees. The system includes: a user terminal in which a taxi driver education app is installed; and a server which communicates with the user terminal by a communication network to provide the taxi driver education app, in which a non-face-to-face taxi education is performed through the taxi driver education app.

### CROSS-REFERENCE TO RELATED APPLICATIONS

This application claims the priority of Korean Patent Application No. 10-2020-0092733, filed on Jul. 27, 2020, in the Korean Intellectual Property Office, the disclosure of which is incorporated herein by reference.

### BACKGROUND OF THE INVENTION

### Field of the Invention

The present invention relates to a system and a method for educating a taxi driver, and more particularly, to a system and a method for educating a taxi driver platform using augmented reality and virtual reality.

### Description of the Related Art

In general, taxis are used by users for business trips, travel, or convenient transportation.

Conventionally, taxis have been a simple means of transportation that replaces public transportation, but taxis that provide various services are gradually increasing at present.

In particular, as the services provided by taxis are diversified, education for taxi drivers who provide services is being actively conducted.

In order for passengers to receive the taxi services conveniently as possible, the taxi services are operated by drivers who have completed a taxi driver training course and provided to the passengers.

As such taxi services increase, the importance of the taxi driver training course is being emphasized.

In the past, training was conducted while taxi drivers boarded actual taxis installed in places provided by training companies.

However, there was a problem in that it was difficult to train a large number of professional drivers in a short time due to problems in space or equipment when training a taxi driver while actually boarding the taxi.

In order to solve this problem, Korean Patent Unexampled Publication No. 2017-0078025 tried to solve a space constraint by installing a taxi education device formed only with a part of a taxi in a place provided by an education company.

As a result, it was possible to train more professional drivers in a shorter time than before, but there is still a lack of educational tools required to train the professional drivers more effectively and in recent years, the need to perform education of the professional taxi drivers by a non-face-to-face scheme has been gradually increasing with the occurrence of Corona 119.

### SUMMARY OF THE INVENTION

In order to solve the conventional problem, an object of the present invention is to provide a system and a method for educating a taxi driver platform using augmented reality or virtual reality, which provide a non-face-to-face platform taxi experience education using augmented reality or virtual reality, which switches a legacy offline membership taxi education to a non-face-to-face online education using the augmented reality or virtual reality, and construct a real spatial background using 360-degree images (virtual reality) and add a sense of location using the augmented reality and provide a realistic environment to allow trainees to personally practice an experiential education learning contents through an interaction in a produced environment, thereby increasing an educational learning ability of the trainees.

In order to achieve the object, a system for educating a taxi driver platform using augmented reality or virtual reality according to the present invention includes: a user terminal in which a taxi driver education app is installed; and a server which communicates with the user terminal by a communication network to provide the taxi driver education app, in which a non-face-to-face taxi education is performed through the taxi driver education app.

Further, in the system for educating a taxi driver platform using augmented reality or virtual reality according to the present invention, the server includes a virtual reality unit providing a real image that a taxi driver sees when boarding a taxi driver's seat as pre-photographed virtual image data, a content unit providing taxi driver education related contents, an augmented reality unit providing the taxi driver education related contents provided by the content unit as augmented image data, and a scenario unit providing a scenario for a plurality of situations for educating a taxi driver and a taxi equipment using method to respond to the plurality of situations for each situation or equipment.

In addition, in the system for educating a taxi driver platform using augmented reality or virtual reality according to the present invention, the user terminal includes a taxi driver education app including a display unit overlapping and displaying the virtual image data provided by the virtual reality unit and the augmented image data provided by the augmented reality unit in the user terminal, a voice recognition unit recognizing a voice of the taxi driver and selecting the taxi driver education related contents, and an input unit inputting a response to a query provided by the augmented image data.

Further, in the system for educating a taxi driver platform using augmented reality or virtual reality according to the present invention, through the input unit, the taxi driver education app is able to be restarted, a camera location which is a location base of a user is able to be reset in the virtual image data, or a distance of the camera location is able to be adjusted.

In addition, in the system for educating a taxi driver platform using augmented reality or virtual reality according to the present invention, the virtual image data implements the real image environment over 360 degrees from the location base of the user.

Further, in the system for educating a taxi driver platform using augmented reality or virtual reality cording to the present invention, the server further includes a DB storing the taxi driver education related contents, the scenario, and a learning progress for the taxi driver education made through the contents and the scenario, and a learning unit learning the learning progress of the user through the DB to manage and monitor a progress.

In order to achieve the object, a method for educating a taxi driver platform using augmented reality or virtual reality according to the present invention includes: a first step in which a taxi driver education app is executed; a second step in which an actual image that a taxi driver sees when boarding a taxi driver's seat as virtual image data pre-photographed by a virtual reality unit of a server is displayed in the taxi driver education app of a user terminal; a third step in which taxi driver education related contents provided by a content unit of the server are provided as augmented image data by an augmented reality unit of the server, and the virtual image data is overlapped with the augmented image data and displayed in the taxi driver education app of the user terminal; and a fourth step in which a scenario for a plurality of situations and a taxi equipment using method to respond to the plurality of situations is provided to the taxi driver education app of the user terminal for each situation or equipment by the scenario unit of the server.

Further, in the method for educating a taxi driver platform using augmented reality or virtual reality according to the present invention, the situation is any one of office attendance, boarding, destination confirmation, driving, getting off, or payment.

In addition, in the method for educating a taxi driver platform using augmented reality or virtual reality according to the present invention, the taxi driver education related contents are selected by recognizing a voice of the taxi driver by a voice recognition unit of the user terminal.

Further, in the method for educating a taxi driver platform using augmented reality or virtual reality according to the present invention, the second step to the fourth step are repeatedly performed, so that a taxi driver education is repeatedly learned.

Specific details of other exemplary embodiments are included in “Details for carrying out the invention” and accompanying “drawings”.

Advantages and/or features of the present invention, and a method for achieving the advantages and/or features will become obvious with reference to various exemplary embodiments to be described below in detail together with the accompanying drawings.

However, the present invention is not limited only to a configuration of each exemplary embodiment disclosed below, but may also be implemented in various different forms. The respective exemplary embodiments disclosed in this specification are provided only to complete disclosure of the present invention and to fully provide those skilled in the art to which the present invention pertains with the category of the invention, and the present invention will be defined only by the scope of each claim of the claims.

According to the present invention, it is possible to provide a non-face-to-face platform taxi experience education using augmented reality or virtual reality, which switches a legacy offline membership taxi education to a non-face-to-face online education using the augmented reality or virtual reality, and a real spatial background is constructed using 360-degree images (virtual reality) and a sense of location is added using the augmented reality and a realistic environment is provided to allow trainees to personally practice an experiential education learning contents through an interaction in a produced environment, thereby increasing an educational learning ability of the trainees.

### BRIEF DESCRIPTION OF THE DRAWINGS

FIG. 1 is a configuration diagram illustrating an overall configuration of a system for educating a taxi driver platform using augmented reality or virtual reality according to the present invention.

FIG. 2 is a block diagram illustrating a configuration of a taxi driver education app installed in a user terminal in the system for educating a taxi driver platform using augmented reality or virtual reality according to the present invention.

FIG. 3 is a block diagram illustrating a configuration of a server in the system for educating a taxi driver platform using augmented reality or virtual reality according to the present invention.

FIG. 4 is a diagram illustrating an example of a scenario provided by a scenario unit in the system for educating a taxi driver platform using augmented reality or virtual reality according to the present invention.

FIG. 5 is a diagram illustrating a state in which virtual image data and augmented image data are overlapped and displayed in a taxi driver education app in the system for educating a taxi driver platform using augmented reality or virtual reality according to the present invention.

FIG. 6 is a diagram illustrating a state in which a taxi driver education is repeated in the system for educating a taxi driver platform using augmented reality or virtual reality according to the present invention.

FIG. 7 is a diagram illustrating a state in which a location is implemented through a user terminal in the system for educating a taxi driver platform using augmented reality or virtual reality according to the present invention.

FIG. 8 is a diagram illustrating a difference from a legacy education in the system for educating a taxi driver platform using augmented reality or virtual reality according to the present invention.

FIG. 9 is a flowchart showing an overall flow of a method for educating a taxi driver platform using augmented reality or virtual reality according to the present invention.

### DETAILED DESCRIPTION OF THE PREFERRED EMBODIMENT

Before describing the present invention in detail, the terms or words used in this specification should not be construed as being unconditionally limited to their ordinary or dictionary meanings, and in order for the inventor of the present invention to describe his/her invention in the best way, concepts of various terms maybe appropriately defined and used, and furthermore, the terms or words should be construed as means and concepts which are consistent with a technical idea of the present invention.

That is, the terms used in this specification are only used to describe preferred embodiments of the present invention, and are not used for the purpose of specifically limiting the contents of the present invention, and it should be noted that the terms are defined by considering various possibilities of the present invention.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but further includes any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side”, “other side”, “one side” “other side”, “first”, “second”, etc. are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present invention may be described while being partially exaggerated, reduced, or omitted for sufficiently clearly delivering the spirit of the present invention, and thus the proportion or scale may not be exact.

Further, hereinafter, in describing the present invention, a detailed description of a configuration determined that may unnecessarily obscure the subject matter of the present invention, for example, a detailed description of a known technology including the prior art may be omitted.

Hereinafter, exemplary embodiments of the present invention will be described in detail with reference to related drawings.

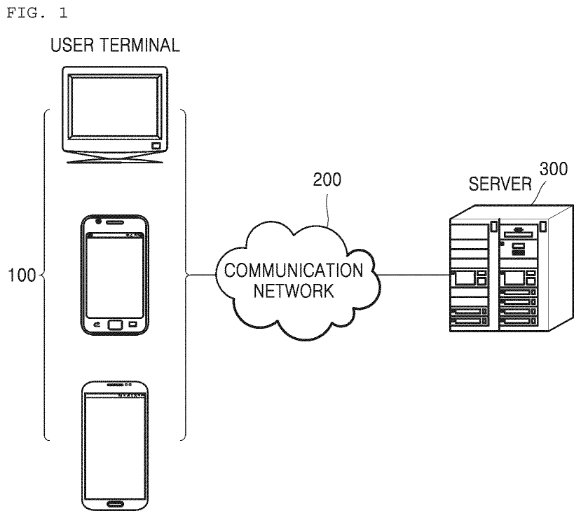

FIG. 1 is a configuration diagram illustrating an overall configuration of a system for educating a taxi driver platform using augmented reality or virtual reality according to the present invention.

Referring to FIG. 1, the system for educating a taxi driver platform using augmented reality or virtual reality according to the present invention includes a user terminal 100, a communication network 200, and a server 300.

The user terminal 100 as an input/output device for a user to communicate with the server 300 may be a PC, a notebook computer, a tablet PC, a smart phone, or the like.

A taxi driver education app is installed in the user terminal 100.

The communication network 200 as a network that allows the user terminal 100 and the server 300 to communicate by wire or wirelessly usually refers to a facility that interconnects facilities and center facilities to perform processing such as exchange, format conversion, processing, and the like of information and the incident processing.

The server 300 serves to communicate with the user terminal 100 through the communication network 200 to provide the taxi driver education app.

As such, the system for educating a taxi driver platform using augmented reality or virtual reality according to the present invention including the user terminal 100, the communication network 200, and the server 300 performs a non-face-to-face taxi driver education through the taxi driver education app provided by the server 300.

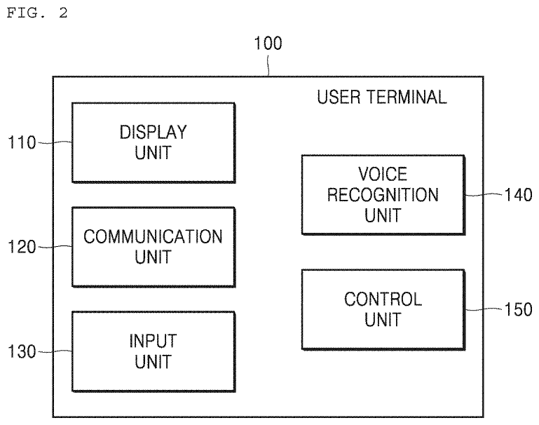

FIG. 2 is a block diagram illustrating a configuration of a taxi driver education app installed in a user terminal in the system for educating a taxi driver platform using augmented reality or virtual reality according to the present invention.

Referring to FIG. 2, the taxi driver education app installed in the user terminal 100 in the system for educating a taxi driver platform using augmented reality or virtual reality according to the present invention includes a display unit 110, a communication unit 120, an input unit 130, a voice recognition unit 140, and a control unit 150.

The display unit 110 serves to display various data provided from the server 300 on the user terminal 100.

More specifically, the display unit 110 overlaps and displays virtual image data provided by a virtual reality unit 320 of the server 300 and augmented image data provided by an augmented reality unit 330 of the server 300 to be described later on the user terminal 100.

The communication unit 120 communicates with a communication unit 310 of the server 300 through the communication network 200.

The input unit 130 serves to input a response to a query provided by the augmented image data provided by the augmented reality unit 330 of the server 300.

The voice recognition unit 140 serves to recognize a voice of a taxi driver and select contents related to taxi driver education to be described later.

The control unit 150 serves to control each of the display unit 110, the communication unit 120, the input unit 130, and the voice recognition unit 140.

As such, by the operation of each component of the taxi driver education app installed in the user terminal 100, the non-face-to-face taxi driver education is performed.

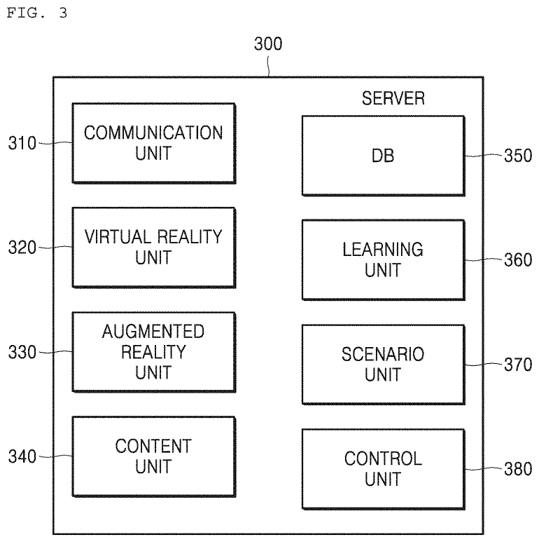

FIG. 3 is a block diagram illustrating a configuration of a server in the system for educating a taxi driver platform using augmented reality or virtual reality according to the present invention.

Referring to FIG. 3, in the system for educating a taxi driver platform using augmented reality or virtual reality according to the present invention, the server 300 includes a communication unit 310, a virtues reality unit 320, and an augmented reality unit 330, a content unit 340, a DB 350, a learning unit 360, a scenario unit 370, and a control unit 380.

The communication unit 310 communicates with the communication unit 120 of the taxi driver education app installed in the user terminal 100 through the communication network 200.

The virtual reality unit 320 serves to provide a real image that a taxi driver sees when boarding a taxi driver's seat as pre-photographed virtual image data.

The content unit 340 serves to provide taxi driver education related contents.

Here, the taxi driver education-related contents include a taxi internal environment, an application practice environment, operating devices (meters, emergency lights, card readers, etc.).

The augmented reality unit 330 serves to provide the taxi driver education related contents provided by the content unit 340 as the augmented image data.

The DB 350 stores taxi driver education related contents, a scenario, and a learning progress for the taxi driver education made through the contents and the scenario.

The learning unit 360 serves to learn the learning progress of a user through the DB 350 to manage and monitor a progress of the user.

The scenario unit 370 serves to provide a scenario for a plurality of situations for reeducating a taxi driver and a taxi equipment using method to respond to the plurality of situations for each situation or for each equipment.

The control unit 330 serves to control each component.

As such, by the operation of each component of the server 300, the present invention may provide a customized taxi driver education simulation so as to respond to customers and operate equipment for each situation by implementing a taxi internal environment, an application practice environment, operating devices (meters, emergency lights, card readers, etc.) as the augmented image data.

That is, the present invention may provide a non-face-to-face taxi driver experience education of switching a legacy offline practice education to a non-face-to-face education using the virtual reality and the augmented reality.

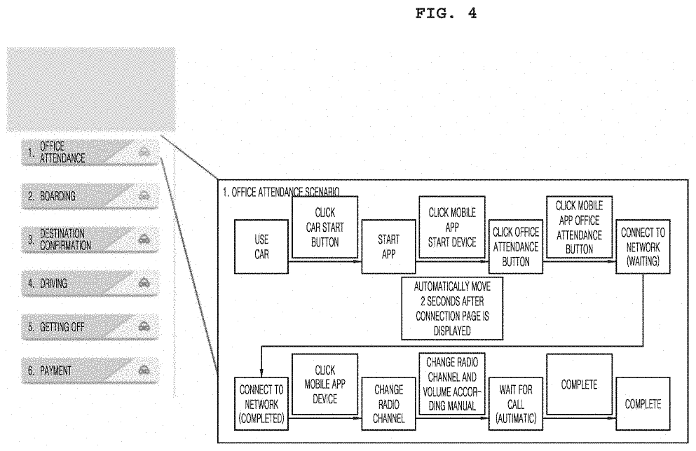

FIG. 4 is a diagram illustrating an example of a scenario provided by a scenario unit in the system for educating a taxi driver platform using augmented reality or virtual reality according to the present invention.

Referring to FIG. 4, in the method for educating a taxi driver platform using augmented reality or virtual reality according to the present invention, the situation of the scenario provided by the scenario unit 370 may be any one of office attendance, boarding, destination confirmation, driving, getting off, or payment.

For ease of description, in the present invention, the scenario is described as described above, but the present invention is not limited thereto, and more scenarios may be generated according to a taxi education situation.

Examples of the scenario of the present invention include office attendance, boarding destination confirmation, driving, getting-off, payment, etc.

In respect to the office attendance among the situations, an office attendance scenario is as follows.

The office attendance scenario includes starting a car, starting the app, clicking a go attendance button, connecting to a network (waiting), connecting to the network (completed), changing a radio channel, waiting for a call (automatic), and completion.

Starting the car is made by clicking a car start button among the contents provided as the augmented image data by the augmented reality unit 330.

Starting the app is made by clicking a mobile app start device among the contents provided as the augmented image data by the augmented reality unit 330.

Clicking the office attendance button is made by clicking a mobile app start button among the contents provided as the augmented image data by the augmented reality unit 330.

In connecting to the network (waiting), connecting to the network is automatically made approximately 2 seconds after a connection page is displayed.

Connecting to the network (completed) is made by clicking a mobile app device among, the contents provided as the augmented image data by the augmented reality unit 330.

Changing the radio channel is made by changing the radio channel and a volume according to a manual among the contents provided as the augmented image data by the augmented reality unit 330.

Waiting for a call (automatic) is automatically made, and completion. is made by clicking a completion button among the contents provided as the augmented image data by the augmented reality unit 330.

By the office attendance scenario, the present invention may provide a realistic taxi driver education environment using the virtual reality and the augmented reality.

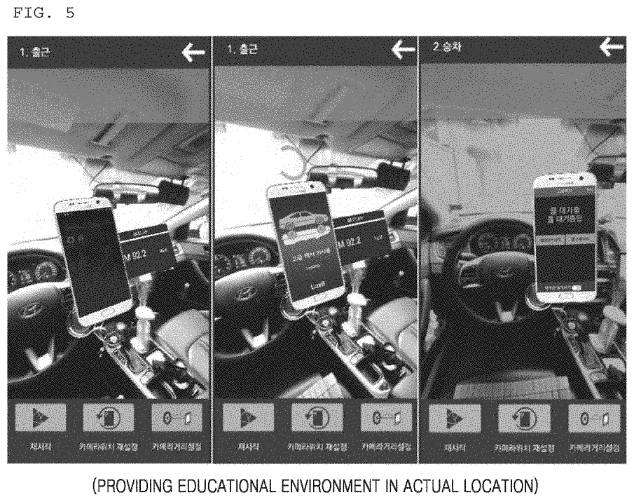

FIG. 5 is a diagram illustrating a state in which virtual image data and augmented image data are overlapped and displayed in a taxi driver education app in the system for educating a taxi driver platform using augmented reality or virtual reality according to the present invention.

Referring to FIG. 5, in the system for educating a taxi driver platform using augmented reality or virtual reality according to the present invention, through the taxi driver education app installed in the user terminal 100, the user may perform the following input.

That is, the taxi driver education app may be restarted by clicking a restart button provided by the augmented reality unit 330 of the server 300.

Further, by clicking a camera location reset button provided by the augmented reality unit 330 of the server 300, a camera location which is the user's location-based viewpoint in the virtual image data may be reset.

Preferably, the camera location may be reset to the initial camera location.

Meanwhile, by clicking a camera distance setting button provided by the augmented reality unit 330 of the server 300, it is possible to adjust a distance of the camera location which is the user's location-based viewpoint.

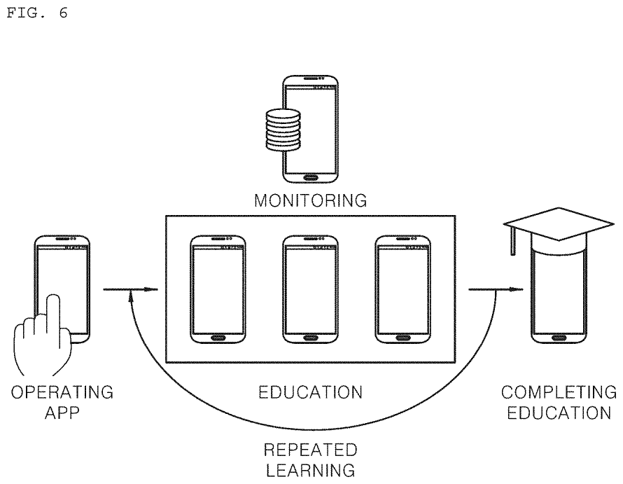

FIG. 6 is a diagram illustrating a state in which a taxi driver education is repeated in the system for educating a taxi driver platform using augmented reality or virtual reality according to the present invention.

Referring to FIG. 6, in the system for educating a taxi driver platform using augmented reality or virtual reality according to the present invention, the server 300 further includes a DB 350 and a learning unit 360.

The DB 350 stores the taxi driver education related contents, a scenario, and a learning progress for the taxi driver education made through the contents and the scenario.

Further, the learning unit 360 serves to earn the learning progress of a user through the DB 350 to manage and monitor a progress of the user.

The server 300 may also serve as an artificial intelligence (AI) server that performs learning by the learning unit 360.

Meanwhile, such progress management and monitoring may be performed through an administrator user terminal.

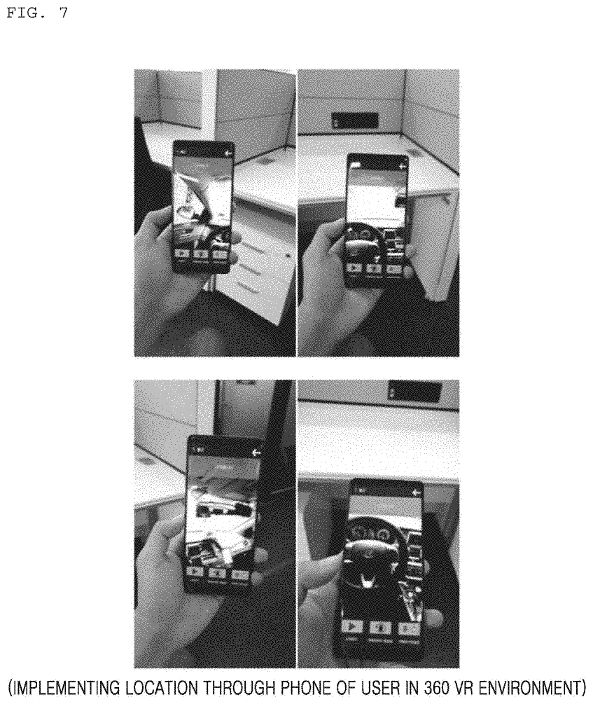

FIG. 7 is a diagram illustrating a state in which a location is implemented through a user terminal in the system for educating a taxi driver platform using augmented reality or virtual reality according to the present invention.

Referring to FIG. 7, in the system for educating a taxi driver platform using augmented reality or virtual reality according to the present invention, the virtual image data by the virtual reality unit 320 implements a real image environment over 360 degrees from a location base of the user.

In other words, the location may be implemented at all of 360 degrees through a phone of the user the user's phone in a virtual environment.

In this way, a real space background is constructed using a 360-degree virtual image data image (VR), and a sense of location is added using the augmented image data by the augmented reality unit 330 to provide a realistic environment so that a trainee may personally practice experiential taxi education learning contents through an interaction in an environment in which produced virtual image data and augmented image data are overlapped, thereby increasing a taxi education learning ability of the trainee.

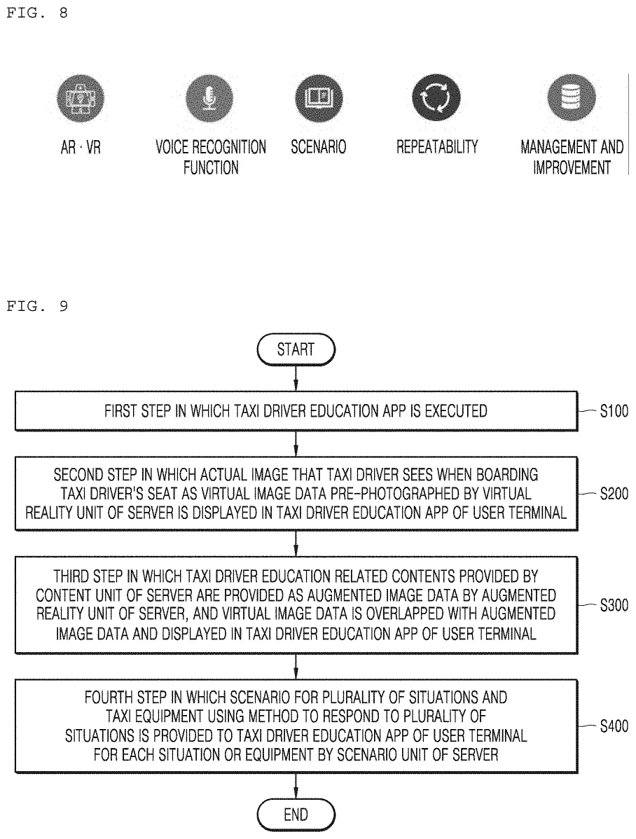

FIG. 8 is a diagram illustrating a difference from a legacy education in the system for educating a taxi driver platform using augmented reality or virtual reality according to the present invention.

Referring to FIG. 8, a difference between the system for educating a taxi driver platform using augmented reality or virtual reality according to the present invention and the legacy education is the use of the augmented reality or the virtual reality, a voice recognition function, the scenario, repeatability, and management/improvement.

In the use of the augmented reality or the virtual reality, the virtual reality constructs a visual experience environment by using the virtual image data in which a real image environment is implemented over 360 degrees from the location base of the user by the virtual reality unit 320 of the server 300.

The augmented reality constructs a user location-based spatial experience environment using the augmented reality by the augmented reality unit 330 of the server 300.

By using such virtual reality and augmented reality, a non-face-to-face realistic educational environment is provided.

The voice recognition function may construct a friendly training and greeting practice through voice recognition and monitoring feedback, and performance confirmation and evaluation environment by the voice recognition unit 140 of the taxi driver training app installed in the user terminal.

The scenario allows the user to receive a taxi education through various countermeasure scenarios for each situation and equipment to enable the realistic educational environment and an interaction between users.

In respect to the repeatability, through a uniformly repeated educational environment, repeated learning (e.g., greetings, comments, situations, etc.) is possible.

FIG. 9 i s a flowchart showing an overall flow of a method for educating a taxi driver platform using augmented reality or virtual reality according to the present invention.

Referring to FIG. 9, the method for educating a taxi driver platform using augmented reality or virtual reality according to the present invention is constituted by four steps.

In a first step (S100), the taxi driver education app installed in the user terminal 100 is executed.

In a second step (S200), the actual image that the taxi driver sees when boarding the taxi driver's seat as the virtual image data previously photographed by the virtual reality unit 320 of the server 300 is displayed in the taxi driver education app of the user terminal 100.

In a third step (S300), the taxi driver education related contents provided by the content unit 340 of the server 300 are provided as the augmented image data by the augmented reality unfit 330 of the server 300, and the virtual image data and the augmented image data are overlapped and displayed in the taxi driver education app of the user terminal 100.

In a fourth step (S400), a scenario for a plurality of situations and a taxi equipment using method to respond to the plurality of situations is provided to the taxi driver education app of the user terminal 100 by the scenario unit 370 of the server 300 for each situation or equipment.

In this case, in the method for educating a taxi driver platform using augmented reality or virtual reality according to the present invention, the situation is any one of office attendance, boarding, destination confirmation, driving, getting off, or payment.

As described above, for ease of description, in the present invention, the scenario is described as described above, but the present invention is not limited thereto, and more scenarios may be generated according to a taxi education situation.

Examples of the scenario of the present invention include office attendance, boarding destination confirmation, driving, getting-off, payment, etc.

In respect to the office attendance among the situations, an office attendance scenario is as follows.

The office attendance scenario includes starting a car, starting app, clicking a go attendance button, connecting to a network (waiting), connecting to the network (completed), changing a radio channel, waiting for a call (automatic), and completion.

Starting the car is made by clicking a car start button among the contents provided as the augmented image data by the augmented reality unit 330.

Starting the app is made by clicking a mobile app start device among the contents provided as the augmented image data by the augmented reality unit 330.

Clicking the office attendance button is made by clicking a mobile app start button click among the contents provided as the augmented image data by the augmented reality unit 330.

In connecting to the network (waiting), connecting to the network is automatically made approximately 2 seconds after a connection page is displayed.

Connecting to the network (completed) is made by clicking a mobile app device among the contents provided as the augmented image data by the augmented reality unit 330.

Changing the radio channel is made by changing the radio channel and a volume according to a manual among the contents provided as the augmented image data by the augmented reality unit 330.

Waiting for a call (automatic) is automatically made, and completion is made by clicking a completion button among the contents provided as the augmented image data by the augmented reality unit 330.

By the office attendance scenario, the present invention may provide a realistic taxi driver education environment using the virtual reality and the augmented reality.

In addition, in the method for educating a taxi driver platform using augmented reality or virtual reality according to the present invention, the taxi driver education-related contents is selected by recognizing the voice of the taxi driver by the voice recognition unit 140 of the user terminal. 100.

Meanwhile, the above-described second step to the above-described fourth step are repeatedly performed, so that the taxi driver education is repeatedly learned.

In other words, a taxi work environment is rapidly changing to enhance customer convenience, and companies participating in the mobility are focusing on the settlement of mobile-based paging services, high-quality services, and safe driving since a mobile taxi industry is just growing.

In spite of high levels of a transportation system, an infrastructure, and a system, in terms of quality, transportation workers are inexperienced in how to use apps installed on smart phones, do not properly utilize real-time traffic information functions, and due to inexperienced operating of terminals and meters, there is a lack of countermeasures against this, there are still very few skilled transport workers based on mobility, and even though the ability to use app devices in the field is very weak, which has a large direct impact on service quality, due to absence of a systematic high-skilled driver education system, it is insufficient to properly manage and nurture the capabilities of skilled transport workers at the organizational level.

Accordingly, the present invention was made, and the economic feasibility according to the present invention is about 250,000 individual and corporate taxis nationwide as of the end of last year, and there are about 70,000 in Seoul where competition for new services is fierce.

It is expected that considerable cost will be consumed to educate them all, and the effect of reducing the resources consumed for education by using the application is expected.

Despite the high levels of the transportation system or the infrastructure, and the system, drivers do not properly use the app functions installed on smartphones, and safe driving and countermeasures against customer complaints are insufficient.

In order to provide differentiated services, it is necessary to strengthen the education in terms of convenience of transport workers so as to use results of big data analysis that analyzes service patterns for the education, and perform ICT skill proficiency and premium service competency training anytime, anywhere.

In this regard, according to the present invention, it is possible to provide a non-face-to-face platform taxi experience education using augmented reality or virtual reality, which switches a legacy offline membership taxi education a non-face-to-face online education using the augmented reality or virtual reality, and a real spatial background is constructed using 360-degree images (virtual reality) and a sense of location is added using the augmented reality and a realistic environment is provided to allow trainees to personally practice an experiential education learning contents through an interaction in a produced environment, thereby increasing an educational learning ability of the trainees.

In the above, although several preferred embodiments of the present invention have been described with some examples, the descriptions of various exemplary embodiments described in the “Specific Content for Carrying Out the Invention” item are merely exemplary, and it will be appreciated by those skilled in the art that the present invention can be variously modified and carried. out or equivalent executions to the present invention can be performed from the above description.

In addition, since the present invention can be implemented in various other forms, the present invention is not limited by the above description, and the above description is for the purpose of completing the disclosure of the present invention, and the above description is just provided to completely inform those skilled in the art of the scope of the present invention, and it should be known that the present invention is only defined by each of the claims.

What is claimed is:

1. A. system for educating a taxi driver platform using augmented reality or virtual reality, the system comprising:
a user terminal in which a taxi driver education app is installed; and
a server which communicates with the user terminal by a communication network to provide the taxi driver education app,
wherein a non-face-to-face taxi education is performed through the taxi driver education app.

2. The system of claim 1, wherein the server includes
a virtual reality unit providing a real image that a taxi driver sees when boarding a taxi driver's seat as pre-photographed virtual image data,
a content unit providing taxi driver education related contents,
an augmented reality unit providing the taxi driver education related contents provided by the content unit as augmented image data, and
a scenario unit providing a scenario for a plurality of situations for educating a taxi driver and a taxi equipment using method to respond to the plurality of situations for each situation or equipment.

3. The system of claim 2, wherein the user terminal includes a taxi driver education app including
a display unit overlapping and displaying the virtual image data provided by the virtual reality unit and the augmented image data provided by the augmented reality unit in the user terminal,
a voice recognition unit recognizing a voice of the taxi driver and selecting the taxi driver education related contents, and
an input unit inputting a response to a query provided by the augmented image data.

4. The system of claim 3, wherein through the input unit, the taxi driver education app is able to be restarted, a camera location which is a location base of a user is able to be reset in the virtual image data, or a distance of the camera location is able to be adjusted.

5. The system of claim 2, wherein the virtual image data implements the real image environment over 360 degrees from the location base of the user.

6. The system of claim. 2, wherein the server further includes
a DB storing the taxi driver education related contents, the scenario, and a learning progress for the taxi driver education made through the contents and the scenario, and
a learning unit learning the learning progress of the user through the DB to manage and monitor a progress.

7. A method for educating a taxi driver platform using augmented reality or virtual reality, the method comprising:
a first step in which a taxi driver education app is executed;
a second step in which an actual image that a taxi driver sees when boarding a taxi driver's seat as virtual image data pre-photographed by a virtual reality unit of a server is displayed in the taxi driver education app of a user terminal;
a third step in which taxi driver education related contents provided by a content unit of the server are provided as augmented image data by an augmented reality unit of the server, and the virtual image data is overlapped with the augmented image data and displayed in the taxi driver education app of the user terminal; and
a fourth step in which a scenario for a plurality of situations and a taxi equipment using method to respond to the plurality of situations is provided to taxi driver education app of the user terminal for each situation or equipment by the scenario unit of the server.

8. The method of claim 7, wherein the situation is any one of office attendance, boarding, destination confirmation, driving, getting off, or payment.

9. The method of claim 7, wherein the taxi driver education related contents are selected by recognizing a voice of the taxi driver by a voice recognition unit of the user terminal.

10. The method of claim 7, wherein the second step to the fourth step are repeatedly performed, so that a taxi driver education is repeatedly learned.
